(19) United States
(12) Patent Application Publication
(10) Pub. No.: US 2026/0171906 A1
(43) Pub. Date: Jun. 18, 2026

(54) CONTROLLER APPLIED TO AN LLC RESONANT POWER CONVERTER

(71) Applicant: Leadtrend Technology Corp., Hsinchu County (TW)

(72) Inventors: Yao-Tsung Chen, Hsinchu County (TW); Kuan-Hsien Chou, Hsinchu County (TW)

(73) Assignee: Leadtrend Technology Corp., Hsinchu County (TW)

(21) Appl. No.: 19/034,530

(22) Filed: Jan. 22, 2025

(30) Foreign Application Priority Data
Dec. 16, 2024 (TW) 113148845

(51) Int. Cl. H02M 3/00; H02M 1/00

(52) U.S. Cl. CPC H02M 3/01; H02M 1/0032

(57) ABSTRACT

A controler applied to an LLC resonant power converter includes a threshold voltage generation circuit and a gate control signal generation circuit. The threshold voltage generation circuit is used for generating an upper threshold voltage and a lower threshold voltage according to a reference voltage, a feedback voltage, and a gate control signal phase. The gate control signal generation circuit is used for disabling an upper bridge control signal according to a sensing voltage and the upper threshold voltage or disabling an lower bridge control signal according to the sensing voltage and the lower threshold voltage, wherein an upper bridge switch of the LLC resonant power converter is turned on according to the upper bridge control signal, and an lower bridge switch of the LLC resonant power converter is turned on according to the lower bridge control signal.

### BACKGROUND OF THE INVENTION

### 1. Field of the Invention

The present invention relates to a controller applied to an LLC resonant power converter, and particularly to a controller that can compensate delay caused by internal components and external components of the controller.

### 2. Description of the Prior Art

In an LLC resonant power converter using the bang-bang charge control (BBCC) method, because an input voltage and a switching frequency at a full output load can be considered as constant values, output power P0 of the LLC resonant power converter can be referred to equation (1):

$$P 0 = k * Δ VFBC \qquad ( 1 )$$

As shown in equation (1), k is a constant and ΔVFBC is a sensing voltage on a pin of a controller applied to the LLC resonant power converter. Therefore, as shown in equation (1), the output power P0 can be determined by the sensing voltage ΔVFBC, so both an output load corresponding to over-current protection (OCP) and an output load corresponding to entering standby mode can be set through the sensing voltage ΔVFBC.

However, in fact, delay caused by internal components and external components of the controller will make actual output power exceed the output power P0 by output power PD, so the output load corresponding to over-current protection and the output load corresponding to entering standby mode which are set through the sensing voltage ΔVFBC will include shift corresponding to the output power PD. Therefore, how to eliminate the above-mentioned disadvantage of the prior art has become an important issue of a designer of the controller.

### SUMMARY OF THE INVENTION

An embodiment of the present invention provides a controller applied to an LLC resonant power converter. The controller includes a threshold voltage generation circuit and a gate control signal generation circuit. The threshold voltage generation circuit is used for generating an upper threshold voltage and a lower threshold voltage according to a reference voltage, a feedback voltage and a gate control signal phase. The gate control signal generation circuit is used for disabling an upper bridge control signal according to a sensing voltage and the upper threshold voltage or disabling a lower bridge control signal according to the sensing voltage and the lower threshold voltage, wherein an upper bridge switch of the LLC resonant power converter is turned on according to the upper bridge control signal, and a lower bridge switch of the LLC resonant power converter is turned on according to the lower bridge control signal.

According to one aspect of the invention, the gate control signal phase is a first phase or a second phase, the first phase corresponds to the upper bridge control signal and the second phase corresponds to the lower bridge control signal.

According to one aspect of the invention, the threshold voltage generation circuit includes a compensation circuit and a voltage adjustment circuit. The compensation circuit is used for receiving a compensation voltage and the reference voltage, wherein the compensation circuit outputs a first voltage according to the first phase, the compensation voltage and the reference voltage, and outputs a second voltage according to the second phase, the compensation voltage and the reference voltage. The voltage adjustment circuit is coupled to the compensation circuit, wherein the voltage adjustment circuit generates the upper threshold voltage according to the feedback voltage and the first voltage, and generates the lower threshold voltage according to the feedback voltage and the second voltage.

According to one aspect of the invention, the compensation circuit includes a first adder and a second adder. The first adder is used for receiving the compensation voltage and the reference voltage and subtracting the compensation voltage from the reference voltage to generate the first voltage. The second adder is used for receiving the compensation voltage and the reference voltage and adding the compensation voltage to the reference voltage to generate the second voltage.

According to one aspect of the invention, the voltage adjustment circuit includes a level circuit and a level shifter. The level circuit is used for generating a voltage level according to the feedback voltage. The level shifter is coupled to the compensation circuit and the level circuit, wherein the level shifter includes a third adder and a fourth adder, the third adder adds the voltage level to the first voltage to generate the upper threshold voltage, and the fourth adder subtracts the voltage level from the second voltage to generate the lower threshold voltage.

According to one aspect of the invention, the gate control signal generation circuit includes a first comparator, a second comparator, a first flip-flop and a second flip-flop. The first comparator is used for receiving the sensing voltage and the upper threshold voltage and generating a first disabling signal according to the sensing voltage and the upper threshold voltage. The second comparator is used for receiving the sensing voltage and the lower threshold voltage and generating a second disabling signal according to the sensing voltage and the lower threshold voltage. The first flip-flop is coupled to the first comparator, wherein the first flip-flop controls disabling and enabling of the upper bridge control signal according to the first disabling signal and an upper bridge enabling signal, respectively. The second flip-flop is coupled to the second comparator, wherein the second flip-flop controls disabling and enabling of the lower bridge control signal according to the second disabling signal and a lower bridge enabling signal, respectively.

According to one aspect of the invention, the upper threshold voltage is greater than the reference voltage and the lower threshold voltage is less than the reference voltage.

According to one aspect of the invention, the power converter is a current mode LLC resonant power converter.

An embodiment of the present invention provides a controller applied to an LLC resonant power converter. The controller includes a threshold voltage generation circuit and a gate control signal generation circuit. The threshold voltage generation circuit is used for generating an upper threshold voltage and a lower threshold voltage according to a reference voltage, a feedback voltage, an upper bridge control signal and a lower bridge control signal. The gate control signal generation circuit is used for disabling the upper bridge control signal according to a sensing voltage and the upper threshold voltage or disabling the lower bridge control signal according to the sensing voltage and the lower threshold voltage, wherein an upper bridge switch of the LLC resonant power converter is turned on according to the upper bridge control signal, and a lower bridge switch of the LLC resonant power converter is turned on according to the lower bridge control signal.

According to one aspect of the invention, the threshold voltage generation circuit includes a compensation circuit and a voltage adjustment circuit. The compensation circuit is used for receiving a compensation voltage, the reference voltage, the upper bridge control signal and the lower bridge control signal, wherein the compensation circuit outputs a first voltage according to the upper bridge control signal, the compensation voltage and the reference voltage, and outputs a second voltage according to the lower bridge control signal, the compensation voltage and the reference voltage. The voltage adjustment circuit is coupled to the compensation circuit, wherein the voltage adjustment circuit generates the upper threshold voltage according to the feedback voltage and the first voltage, and generates the lower threshold voltage according to the feedback voltage and the second voltage.

According to one aspect of the invention, the voltage adjustment circuit includes a level circuit and a level shifter. The level circuit is used for generating a voltage level according to the feedback voltage. The level shifter is coupled to the compensation circuit and the level circuit, wherein the level shifter includes a third adder and a fourth adder, the third adder adds the voltage level to the first voltage to generate the upper threshold voltage, and the fourth adder subtracts the voltage level from the second voltage to generate the lower threshold voltage.

According to one aspect of the invention, the compensation circuit includes a fifth adder and a sixth adder. The fifth adder is used for receiving the compensation voltage and the reference voltage and subtracting the compensation voltage from the reference voltage to generate the first voltage. The sixth adder is used for receiving the compensation voltage and the reference voltage and adding the compensation voltage to the reference voltage to generate the second voltage.

According to one aspect of the invention, the gate control signal generation circuit includes a first comparator, a second comparator, a first flip-flop and a second flip-flop. The first comparator is used for receiving the sensing voltage and the upper threshold voltage and generating a first disabling signal according to the sensing voltage and the upper threshold voltage. The second comparator is used for receiving the sensing voltage and the lower threshold voltage and generating a second disabling signal according to the sensing voltage and the lower threshold voltage. The first flip-flop is coupled to the first comparator, wherein the first flip-flop controls disabling and enabling of the upper bridge control signal according to the first disabling signal and an upper bridge enabling signal, respectively. The second flip-flop is coupled to the second comparator, wherein the second flip-flop controls disabling and enabling of the lower bridge control signal according to the second disabling signal and a lower bridge enabling signal, respectively.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a controller applied to an LLC resonant power converter according to one embodiment of the present invention.

FIG. 2 is a diagram illustrating in the prior art, the upper threshold voltage and the lower threshold voltage shifting due to delay caused by internal components and external components of the controller.

FIG. 3 is a diagram illustrating the gate control signal generation circuit, the compensation circuit and the voltage adjustment circuit.

FIG. 4 is a diagram illustrating the first voltage, the second voltage, the reference voltage, the new upper threshold voltage, the upper threshold voltage, the new lower threshold voltage, the lower threshold voltage, the compensation voltage, the voltage level and the sensing voltage.

FIG. 5 is a diagram illustrating a threshold voltage generation circuit according to another embodiment of the present invention.

FIG. 6 is a diagram illustrating first voltage, the second voltage, the reference voltage, the new upper threshold voltage, the upper threshold voltage, the new lower threshold voltage, the lower threshold voltage, the compensation voltage, the voltage level and the sensing voltage.

FIG. 7 is a diagram illustrating the over-current protection threshold voltage of the over-current protection being set through the voltage level.

FIG. 8 is a diagram illustrating the standby threshold voltage corresponding to the output load of the entering standby mode being also set through the voltage level.

### DETAILED DESCRIPTION

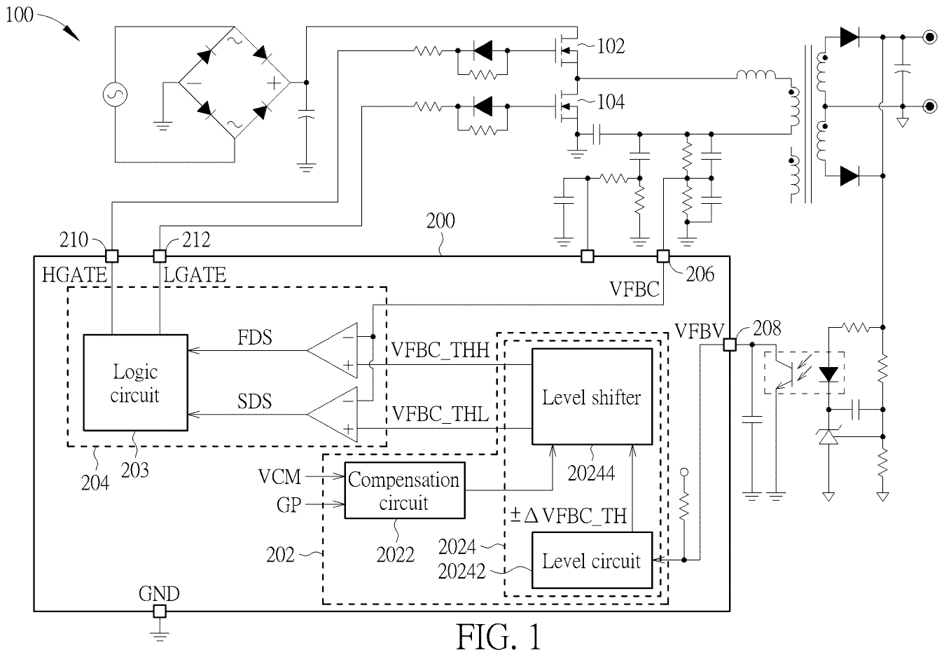

Please refer to FIG. 1. FIG. 1 is a diagram illustrating a controller 200 applied to an LLC resonant power converter 100 according to one embodiment of the present invention, wherein the controller 200 includes a threshold voltage generation circuit 202 and a gate control signal generation circuit 204, the threshold voltage generation circuit 202 includes a compensation circuit 2022 and a voltage adjustment circuit 2024, and coupling relationships between the threshold voltage generation circuit 202, the gate control signal generation circuit 204, the compensation circuit 2022 and voltage adjustment circuit 2024 can be referred to FIG. 1, so further description thereof is omitted for simplicity. In addition, the LLC resonant power converter 100 is a current mode LLC resonant power converter. In actual operation, because a sensing voltage VFBC on a pin 206 of the controller 200 is between a maximum (e.g. (but not limited to) 4V) and a minimum (e.g. (but not limited to) 1V), a reference voltage VCM inputted into the compensation circuit 2022 can be set to 2.5V which is a middle value between the maximum and the minimum, wherein ΔVFBC_PD is a compensation voltage corresponding to delay caused by internal components and external components of the controller 200, and the maximum and the minimum correspond to a maximum output load of the LLC resonant power converter 100. In addition, as shown in FIG. 1, the controller 200 can receive ground potential through a pin GND, V0 is an output voltage of the LLC resonant power converter 100 and VAC is an alternating current input voltage inputted into the LLC resonant power converter 100.

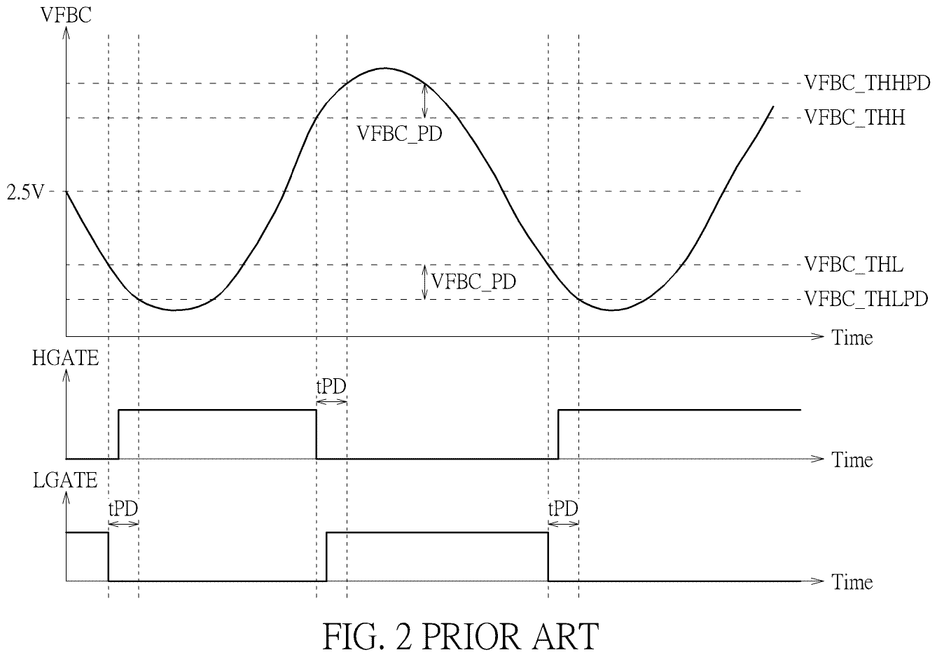

Next, please refer to FIG. 2. In the prior art, as shown in FIG. 2, an upper threshold voltage VFBC_THH generated by the voltage adjustment circuit 2024 will shift upward to a new upper threshold voltage VFBC_THHPD because of the compensation voltage ΔVFBC_PD and a lower threshold voltage VFBC_THL generated by the voltage adjustment circuit 2024 will also shift downward to a new lower threshold voltage VFBC_THLPD because of the compensation voltage ΔVFBC_PD, so that an upper bridge control signal HGATE and a lower bridge control signal LGATE generated by the gate control signal generation circuit 204 will be delayed to be disabled, wherein tPD is a delay time, the upper threshold voltage VFBC_THH is greater than the reference voltage VCM, and the lower threshold voltage VFBC_THL is less than the reference voltage VCM.

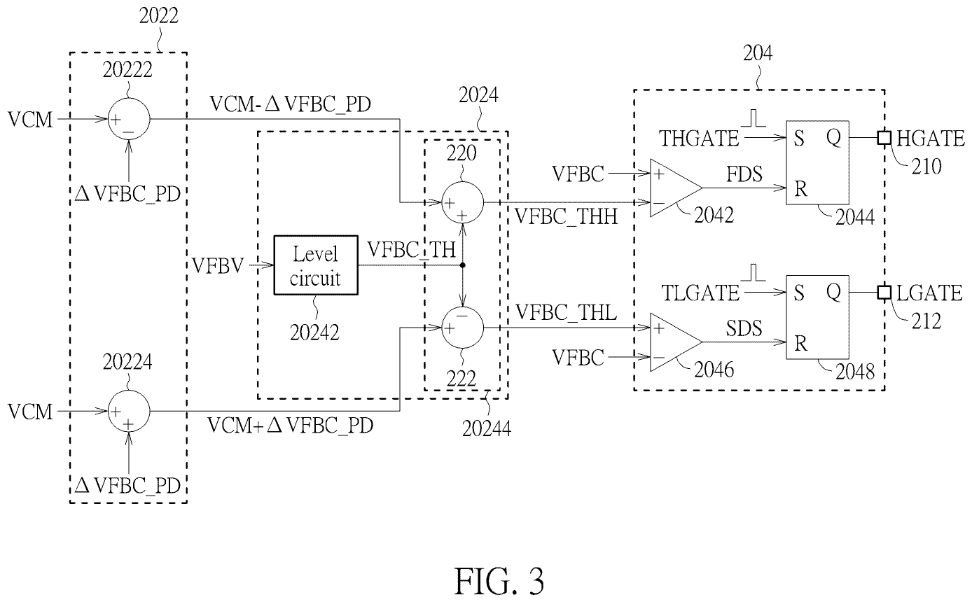

Next, as shown in FIG. 3, the compensation circuit 2022 includes a first adder 20222 and a second adder 20224, the first adder 20222 can subtract the compensation voltage ΔVFBC_PD from the reference voltage VCM to generate a first voltage VCM−ΔVFBC_PD, and the second adder 20224 can add the compensation voltage ΔVFBC_PD to the reference voltage VCM to generate a second voltage VCM+ΔVFBC_PD. When a gate control signal phase GP inputted into the compensation circuit 2022 is a first phase, the compensation circuit 2022 outputs the first voltage VCM−ΔVFBC_PD, and when the gate control signal phase GP is a second phase, the compensation circuit 2022 outputs the second voltage VCM+ΔVFBC_PD, wherein the first phase corresponds to the upper bridge control signal HGATE, and the second phase corresponds to the lower bridge control signal LGATE.

As shown in FIG. 3, the voltage adjustment circuit 2024 includes a level circuit 20242 and a level shifter 20244, the level circuit 20242 can receive a feedback voltage VFBV from an optocoupler 101 of the LLC resonant power converter 100 through a pin 208 of the controller 200, and generate a voltage level VFBC_TH according to the feedback voltage VFBV, wherein the voltage level VFBC_TH is changed according to the practical design requirements. When a third adder 220 within the level shifter 20244 receives the first voltage VCM−ΔVFBC_PD (corresponding to the first phase), the third adder 220 can add the voltage level VFBC_TH to the first voltage VCM−ΔVFBC_PD to generate the upper threshold voltage VFBC_THH; when a fourth adder 222 within the level shifter 20244 receives the second voltage VCM+ΔVFBC_PD (corresponding to the second phase), the fourth adder 222 can subtract the voltage level VFBC_TH from the second voltage VCM+ΔVFBC_PD to generate the lower threshold voltage VFBC_THL.

As shown in FIG. 3, the gate control signal generation circuit 204 includes a first comparator 2042, a first flip-flop 2044, a second comparator 2046 and a second flip-flop 2048. The first comparator 2042 is coupled to the third adder 220 and the pin 206 of the controller 200, wherein the first comparator 2042 receives the sensing voltage VFBC and the upper threshold voltage VFBC_THH and generates a first disabling signal FDS according to the sensing voltage VFBC and the upper threshold voltage VFBC_THH; when the first flip-flop 2044 receives the first disabling signal FDS, the first flip-flop 2044 disables the upper bridge control signal HGATE according to the first disabling signal FDS. In addition, the first flip-flop 2044 and the second flip-flop 2048 are included in a logic circuit 203 shown in FIG. 1. In addition, when the first flip-flop 2044 receives an upper bridge enabling signal THGATE generated by an enabling signal generation circuit (not shown in FIG. 1 and FIG. 2) within the gate control signal generation circuit 204, the first flip-flop 2044 enables the upper bridge control signal HGATE according to the upper bridge enabling signal THGATE. As shown in FIG. 3, the second comparator 2046 is coupled to the fourth adder 222 and the pin 206 of the controller 200, wherein the second comparator 2046 receives the sensing voltage VFBC and the lower threshold voltage VFBC_THL and generates a second disabling signal SDS according to the sensing voltage VFBC and the lower threshold voltage VFBC_THL; when the second flip-flop 2048 receives the second disabling signal SDS, the second flip-flop 2048 disables the lower bridge control signal LGATE according to the second disabling signal SDS. In addition, when the second flip-flop 2048 receives a lower bridge enabling signal TLGATE generated by the enabling signal generation circuit (not shown in FIG. 1 and FIG. 2), the second flip-flop 2048 enables the lower bridge control signal LGATE according to the lower bridge enabling signal TLGATE, wherein an upper bridge switch 102 of the LLC resonant power converter 100 is turned on according to the upper bridge control signal HGATE, and a lower bridge switch 104 of the LLC resonant power converter 100 is turned on according to the lower bridge control signal LGATE. In addition, as shown in FIG. 1, the logic circuit 203 transmits the upper bridge control signal HGATE to the upper bridge switch 102 through a pin 210 of the controller 200, and transmits the lower bridge control signal LGATE to the lower bridge switch 104 through a pin 212 of the controller 200.

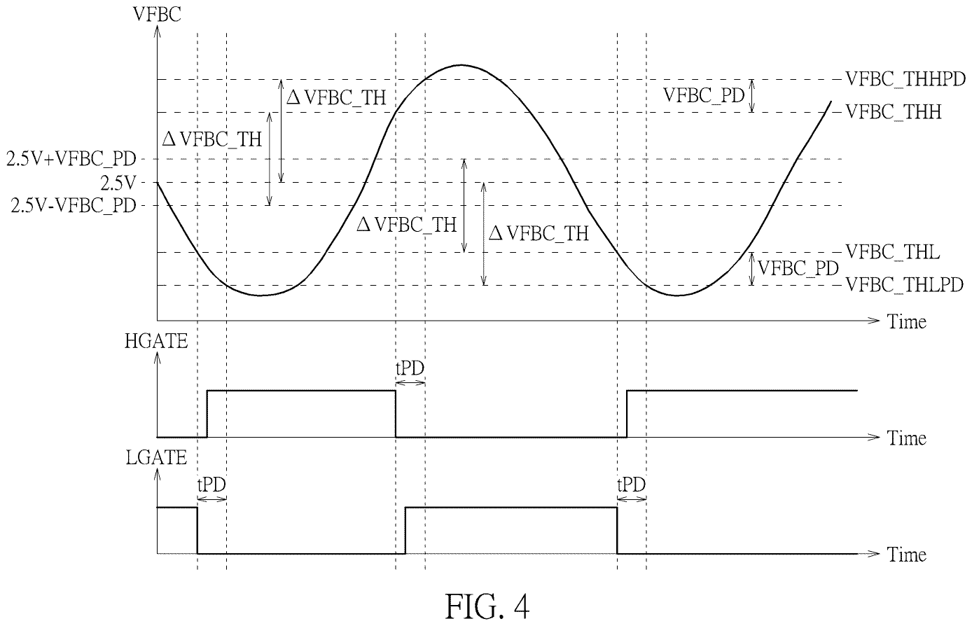

As shown in FIG. 4, because the first voltage VCM−ΔVFBC_PD and the second voltage VCM+ΔVFBC_PD generated by the compensation circuit 2022 have included information of the compensation voltage ΔVFBC_PD, the first voltage VCM−ΔVFBC_PD and the second voltage VCM+ΔVFBC_PD can counteract influences (shown in FIG. 2) of the compensation voltage ΔVFBC_PD on the new upper threshold voltage VFBC_THHPD and the new lower threshold voltage VFBC_THLPD to make the new upper threshold voltage VFBC_THHPD restore to the upper threshold voltage VFBC_THH and the new lower threshold voltage VFBC_THLPD restore to the lower threshold voltage VFBC_THL. Thus, because the new upper threshold voltage VFBC_THHPD restores to the upper threshold voltage VFBC_THH and the new lower threshold voltage VFBC_THLPD restores to the lower threshold voltage VFBC_THL, both the upper bridge control signal HGATE and the lower bridge control signal LGATE are not delayed to be disabled.

In addition, coupling relationships between the first adder 20222, the second adder 20224, the level circuit 20242, the third adder 220, the fourth adder 222, the first comparator 2042, the first flip-flop 2044, the second comparator 2046 and the second flip-flop 2048 can be referred to FIG. 3, so further description thereof is omitted for simplicity.

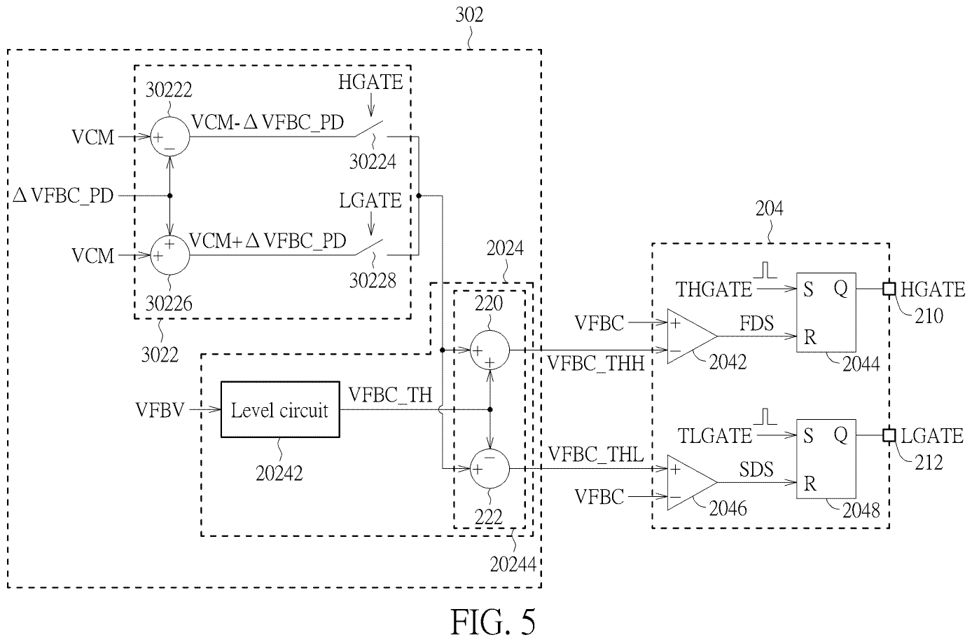

Next, please refer to FIG. 5. FIG. 5 is a diagram illustrating a threshold voltage generation circuit 302 according to another embodiment of the present invention, wherein a function of the threshold voltage generation circuit 302 is the same as that of the threshold voltage generation circuit 202, and the threshold voltage generation circuit 302 includes a compensation circuit 3022 and the voltage adjustment circuit 2024. As shown in FIG. 5, the compensation circuit 3022 includes a fifth adder 30222, a first switch 30224, a sixth adder 30226 and a first switch 30228, wherein the fifth adder 30222 can subtract the compensation voltage ΔVFBC_PD from the reference voltage VCM to generate the first voltage VCM−ΔVFBC_PD, and the sixth adder 30226 can add the compensation voltage ΔVFBC_PD to the reference voltage VCM to generate the second voltage VCM+ΔVFBC_PD.

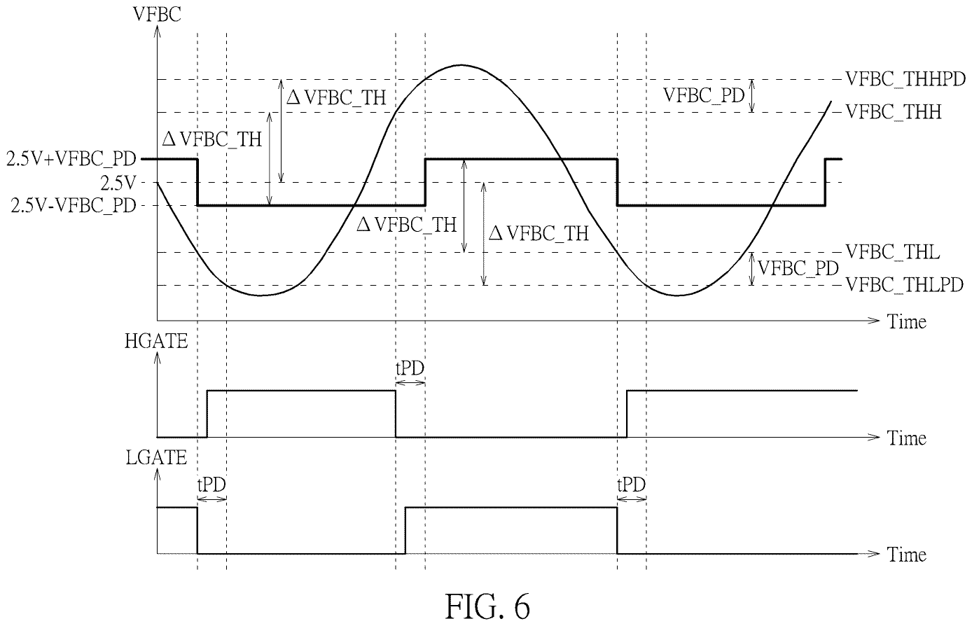

As shown in FIG. 5, when the upper bridge control signal HGATE is enabled and the lower bridge control signal LGATE is disabled, the compensation circuit 3022 outputs the first voltage VCM−ΔVFBC_PD to the voltage adjustment circuit 2024. Meanwhile, the third adder 220 within the level shifter 20244 can add the voltage level VFBC_TH to the first voltage VCM−ΔVFBC_PD to generate the upper threshold voltage VFBC_THH. Next, please simultaneously refer to FIG. 5 and FIG. 6, because the first voltage VCM−ΔVFBC_PD generated by the compensation circuit 3022 has included the information of the compensation voltage ΔVFBC_PD, the first voltage VCM−ΔVFBC_PD can counteract the influences (shown in FIG. 2) of the compensation voltage ΔVFBC_PD on the new upper threshold voltage VFBC_THHPD to make the new upper threshold voltage VFBC_THHPD restore to the upper threshold voltage VFBC_THH. Thus, because the new upper threshold voltage VFBC_THHPD restores to the upper threshold voltage VFBC_THH, the first comparator 2042 and the first flip-flop 2044 of the gate control signal generation circuit 204 don't delay to disable the upper bridge control signal HGATE, wherein operational principles of the gate control signal generation circuit 204 can be referred to the above-mentioned descriptions corresponding to FIG. 3, so further description thereof is omitted for simplicity. In addition, although when the compensation circuit 3022 outputs the first voltage VCM−ΔVFBC_PD to the voltage adjustment circuit 2024, the fourth adder 222 within the level shifter 20244 also operates according to the first voltage VCM−ΔVFBC_PD and the voltage level VFBC_TH, because the lower bridge control signal LGATE is disabled (correspond to disabling of the lower bridge enabling signal TLGATE), the second flip-flop 2048 of the gate control signal generation circuit 204 will disable the lower bridge control signal LGATE continuously.

In addition, as shown in FIG. 5, when the upper bridge control signal HGATE is disabled and the lower bridge control signal LGATE is enabled, the compensation circuit 3022 outputs the second voltage VCM+ΔVFBC_PD to the voltage adjustment circuit 2024. Meanwhile, the fourth adder 222 within the level shifter 20244 can subtract the voltage level VFBC_TH from the second voltage VCM+ΔVFBC_PD to generate the lower threshold voltage VFBC_THL. Next, please simultaneously refer to FIG. 5 and FIG. 6, because the second voltage VCM+ΔVFBC_PD generated by the compensation circuit 3022 has included the information of the compensation voltage ΔVFBC_PD, the second voltage VCM+ΔVFBC_PD can counteract the influences (shown in FIG. 2) of the compensation voltage ΔVFBC_PD on the new lower threshold voltage VFBC_THLPD to make the new lower threshold voltage VFBC_THLPD restore to the lower threshold voltage VFBC_THL. Thus, because the new lower threshold voltage VFBC_THLPD restores to the lower threshold voltage VFBC_THL, the second comparator 2046 and the second flip-flop 2048 of the gate control signal generation circuit 204 don't delay to disable the lower bridge control signal LGATE, wherein the operational principles of the gate control signal generation circuit 204 can be referred to the above-mentioned descriptions corresponding to FIG. 3, so further description thereof is omitted for simplicity. In addition, although when the compensation circuit 3022 outputs the second voltage VCM+ΔVFBC_PD to the voltage adjustment circuit 2024, the third adder 220 within the level shifter 20244 also operates according to the second voltage VCM+ΔVFBC_PD and the voltage level VFBC_TH, because the upper bridge control signal HGATE is disabled (correspond to disabling of the upper bridge enabling signal THGATE), the first flip-flop 2044 of the gate control signal generation circuit 204 will disable the lower bridge control signal LGATE continuously.

In addition, coupling relationships between the fifth adder 30222, the first switch 30224, the sixth adder 30226, the first switch 30228, the level circuit 20242, the third adder 220, the fourth adder 222, the first comparator 2042, the first flip-flop 2044, the second comparator 2046 and the second flip-flop 2048 can be referred to FIG. 5, so further description thereof is omitted for simplicity.

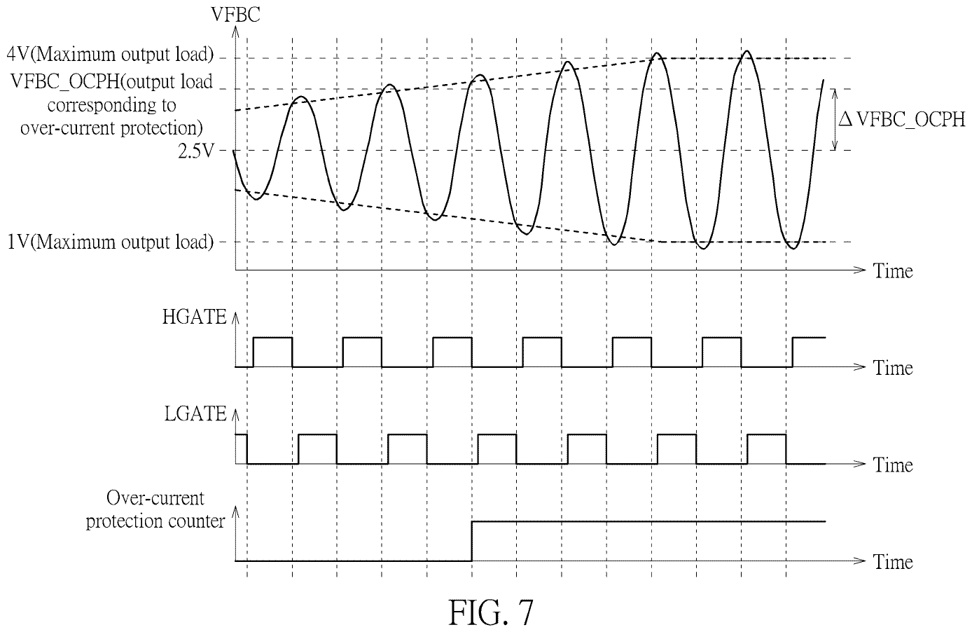

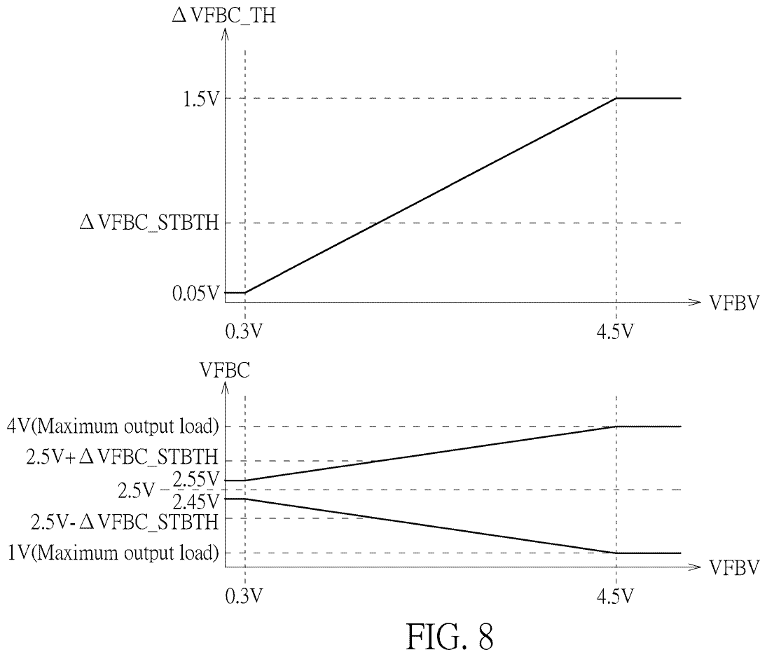

Therefore, as shown in FIG. 4 and FIG. 6, because both of the upper bridge control signal HGATE and the lower bridge control signal LGATE are not delayed to be disabled due to the compensation voltage ΔVFBC_PD, there is an approximately linear relationship between output power P0 of the LLC resonant power converter 100 and the voltage level VFBC_TH. Therefore, because there is the approximately linear relationship between the output power P0 and the voltage level VFBC_TH, both an output load corresponding to over-current protection (OCP) and an output load corresponding to entering standby mode can be set through the voltage level VFBC_TH. Therefore, as shown in FIG. 7, an over-current protection threshold voltage VFBC_OCPH of the over-current protection can be set through the voltage level VFBC_TH, wherein the over-current protection threshold voltage VFBC_OCPH corresponds to the output load of the over-current protection; as shown in FIG. 8, a standby threshold voltage VFBC_STBTH correspond to the output load of the entering standby mode can be also set through the voltage level VFBC_TH. Thus, the present invention can increase accuracy of over-current protection dramatically and reduce the output load corresponding to the entering standby mode.

To sum up, because the first voltage and the second voltage generated by the compensation circuit have included information corresponding to the delay caused by the internal components and the external components of the controller, the present invention can compensate shift in output load detection due to the delay caused by the internal components and the external components of the controller. Thus, the present invention can increase accuracy of over-current protection dramatically and reduce the output load corresponding to the entering standby mode.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A controller applied to an LLC resonant power converter, comprising:
a threshold voltage generation circuit for generating an upper threshold voltage and a lower threshold voltage according to a reference voltage, a feedback voltage and a gate control signal phase; and
a gate control signal generation circuit for disabling an upper bridge control signal according to a sensing voltage and the upper threshold voltage or disabling a lower bridge control signal according to the sensing voltage and the lower threshold voltage, wherein an upper bridge switch of the LLC resonant power converter is turned on according to the upper bridge control signal, and a lower bridge switch of the LLC resonant power converter is turned on according to the lower bridge control signal.

2. The controller of claim 1, wherein the gate control signal phase is a first phase or a second phase, the first phase corresponds to the upper bridge control signal and the second phase corresponds to the lower bridge control signal.

3. The controller of claim 2, wherein the threshold voltage generation circuit comprises:
a compensation circuit for receiving a compensation voltage and the reference voltage, wherein the compensation circuit outputs a first voltage according to the first phase, the compensation voltage and the reference voltage, and outputs a second voltage according to the second phase, the compensation voltage and the reference voltage; and
a voltage adjustment circuit coupled to the compensation circuit, wherein the voltage adjustment circuit generates the upper threshold voltage according to the feedback voltage and the first voltage, and generates the lower threshold voltage according to the feedback voltage and the second voltage.

4. The controller of claim 3, wherein the compensation circuit comprises:
a first adder for receiving the compensation voltage and the reference voltage and subtracting the compensation voltage from the reference voltage to generate the first voltage; and
a second adder for receiving the compensation voltage and the reference voltage and adding the compensation voltage to the reference voltage to generate the second voltage.

5. The controller of claim 3, wherein the voltage adjustment circuit comprises:
a level circuit for generating a voltage level according to the feedback voltage; and
a level shifter coupled to the compensation circuit and the level circuit, wherein the level shifter comprises a third adder and a fourth adder, the third adder adds the voltage level to the first voltage to generate the upper threshold voltage, and the fourth adder subtracts the voltage level from the second voltage to generate the lower threshold voltage.

6. The controller of claim 1, wherein the gate control signal generation circuit comprises:
a first comparator for receiving the sensing voltage and the upper threshold voltage and generating a first disabling signal according to the sensing voltage and the upper threshold voltage;
a second comparator for receiving the sensing voltage and the lower threshold voltage and generating a second disabling signal according to the sensing voltage and the lower threshold voltage;
a first flip-flop coupled to the first comparator, wherein the first flip-flop controls disabling and enabling of the upper bridge control signal according to the first disabling signal and an upper bridge enabling signal, respectively; and
a second flip-flop coupled to the second comparator, wherein the second flip-flop controls disabling and enabling of the lower bridge control signal according to the second disabling signal and a lower bridge enabling signal, respectively.

7. The controller of claim 1, wherein the upper threshold voltage is greater than the reference voltage and the lower threshold voltage is less than the reference voltage.

8. The controller of claim 1, wherein the power converter is a current mode LLC resonant power converter.

9. A controller applied to an LLC resonant power converter, comprising:
a threshold voltage generation circuit for generating an upper threshold voltage and a lower threshold voltage according to a reference voltage, a feedback voltage, an upper bridge control signal and a lower bridge control signal; and
a gate control signal generation circuit for disabling the upper bridge control signal according to a sensing voltage and the upper threshold voltage or disabling the lower bridge control signal according to the sensing voltage and the lower threshold voltage, wherein an upper bridge switch of the LLC resonant power converter is turned on according to the upper bridge control signal, and a lower bridge switch of the LLC resonant power converter is turned on according to the lower bridge control signal.

10. The controller of claim 9, wherein the threshold voltage generation circuit comprises:
a compensation circuit for receiving a compensation voltage, the reference voltage, the upper bridge control signal and the lower bridge control signal, wherein the compensation circuit outputs a first voltage according to the upper bridge control signal, the compensation voltage and the reference voltage, and outputs a second voltage according to the lower bridge control signal, the compensation voltage and the reference voltage; and
a voltage adjustment circuit coupled to the compensation circuit, wherein the voltage adjustment circuit generates the upper threshold voltage according to the feedback voltage and the first voltage, and generates the lower threshold voltage according to the feedback voltage and the second voltage.

11. The controller of claim 10, wherein the voltage adjustment circuit comprises:
a level circuit for generating a voltage level according to the feedback voltage; and
a level shifter coupled to the compensation circuit and the level circuit, wherein the level shifter comprises a third adder and a fourth adder, the third adder adds the voltage level to the first voltage to generate the upper threshold voltage, and the fourth adder subtracts the voltage level from the second voltage to generate the lower threshold voltage.

12. The controller of claim 10, wherein the compensation circuit comprises:
a fifth adder for receiving the compensation voltage and the reference voltage and subtracting the compensation voltage from the reference voltage to generate the first voltage; and
a sixth adder for receiving the compensation voltage and the reference voltage and adding the compensation voltage to the reference voltage to generate the second voltage.

13. The controller of claim 9, wherein the gate control signal generation circuit comprises:
a first comparator for receiving the sensing voltage and the upper threshold voltage and generating a first disabling signal according to the sensing voltage and the upper threshold voltage;
a second comparator for receiving the sensing voltage and the lower threshold voltage and generating a second disabling signal according to the sensing voltage and the lower threshold voltage;
a first flip-flop coupled to the first comparator, wherein the first flip-flop controls disabling and enabling of the upper bridge control signal according to the first disabling signal and an upper bridge enabling signal, respectively; and
a second flip-flop coupled to the second comparator, wherein the second flip-flop controls disabling and enabling of the lower bridge control signal according to the second disabling signal and a lower bridge enabling signal, respectively.
